(19) United States
(12) Patent Application Publication
(10) Pub. No.: US 2023/0100091 A1
(43) Pub. Date: Mar. 30, 2023

(54) SCENARIO GENERATION DEVICE AND SCENARIO GENERATION METHOD

(71) Applicants: J-QuAD DYNAMICS INC., Tokyo (JP); NTT DATA Automobiligence Research Center, Ltd., Yokohama (JP)

(72) Inventors: YUJI ISHIKAWA, Tokyo (JP); MASAKAZU TAMURA, Yokohama (JP)

(21) Appl. No.: 17/936,260

(22) Filed: Sep. 28, 2022

(30) Foreign Application Priority Data
Sep. 30, 2021 (JP) 2021-160455

(51) Int. Cl. B60W 60/00; B60W 50/06

(52) U.S. Cl. CPC B60W 60/0011; B60W 50/06; B60W 2050/0001

(57) ABSTRACT

A scenario generation device includes: a real environment scene obtaining unit obtaining a real environment scene, which is a scene that occurs in a real environment, from a travel database that stores travel data of a real vehicle; a filter generation unit generating a filter for filtering candidate scenarios based on a frequency analysis result of analysis target data including the travel data showing the real environment scene; and an evaluation scenario determination unit determining an evaluation scenario by filtering the candidate scenarios comprehensively generated based on a mathematical model using the filter generated by the filter generation unit.

### CROSS REFERENCE TO RELATED APPLICATION

The present application is based on and claims the benefit of priority of Japanese Patent Application No. 2021-160455, filed on Sep. 30, 2021, the disclosure of which is incorporated herein by reference.

### TECHNICAL FIELD

The present disclosure generally relates to a scenario generation device and a scenario generation method for generating a scenario for evaluating a vehicle control function, and particularly to a technique for effectively reducing the number of scenarios.

### BACKGROUND INFORMATION

Devices and methods for generating scenarios for evaluating vehicle control functions are known. In a relevant patent document, a traffic scenario is enhanced by making a traffic log obtained in a real environment responsive to an event travel environment of a critical event, by using the critical event occurred in the real environment as a condition, which may further be improvable by generating scenarios based on mathematical models.

### SUMMARY

It is an object of the present disclosure is to provide a scenario generation device and a scenario generation method capable of increasing the comprehensiveness of scenarios that occur in a real environment while suppressing the number of scenarios.

### BRIEF DESCRIPTION OF THE DRAWINGS

Objects, features, and advantages of the present disclosure will become more apparent from the following detailed description made with reference to the accompanying drawings, in which:

FIG. 1 is a diagram showing a configuration of a scenario generation device 10 according to a first embodiment;

FIG. 2 is a diagram showing parameters of a mathematical model that defines traffic disturbances;

FIG. 3 is a diagram illustrating a coordinate system of the parameters shown in FIG. 2;

FIG. 4 is a diagram showing equations up to deriving the mathematical model showing deceleration of an other vehicle;

FIG. 5 is a diagram showing a frequency distribution of speeds of a subject vehicle extracted from travel data showing a real environment scene;

FIG. 6 is a diagram showing a frequency distribution of speeds of the other vehicle extracted from travel data showing a real environment scene;

FIG. 7 is a diagram illustrating filtering performed by an evaluation scenario determination unit; and

FIG. 8 is a diagram showing a configuration of a scenario generation device according to a second embodiment.

### DETAILED DESCRIPTION

### First Embodiment The following describes embodiments of the present disclosure with

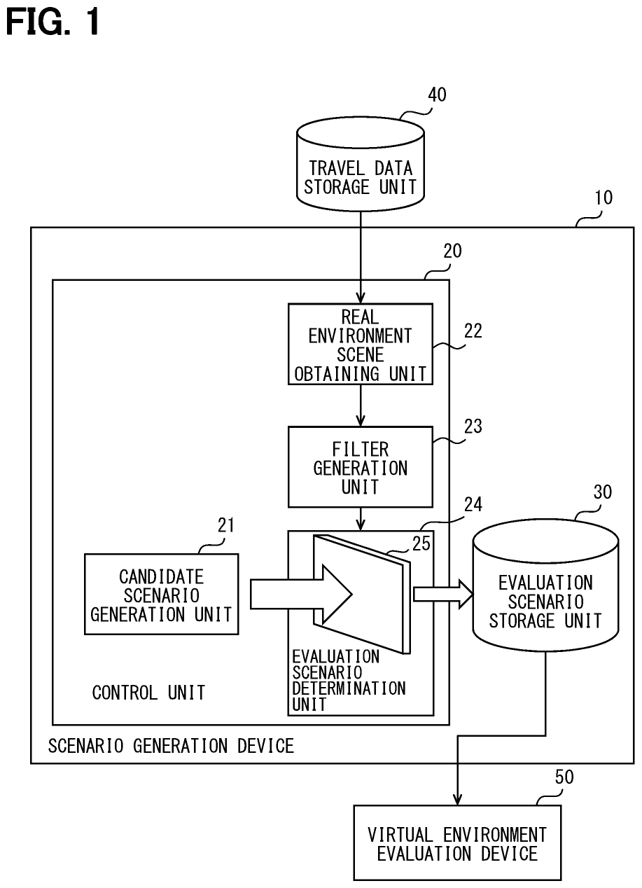

reference to the drawings. FIG. 1 is a diagram showing a configuration of a scenario generation device 10 of the first embodiment. The scenario generation device 10 is a device that generates an evaluation scenario for evaluating the performance of a vehicle control function that controls a travel of a vehicle. Hereinafter, the vehicle for which the vehicle control function is evaluated will be referred to as a subject vehicle.

The vehicle control function is not limited to a function of automatically driving the subject vehicle, but also includes a function of controlling a travel of the subject vehicle in order to assist the driver's driving operation. A scenario means from the beginning to the end of a series of behaviors of the subject vehicle. The start and end of a series of behaviors can be set arbitrarily. For example, a scenario may describe a situation in which an other vehicle cuts in in front of the subject vehicle. The start of such scenario may be a timing when the other vehicle starts a lateral movement, and the end of such scenario may be a timing when the lateral movement of the other vehicle ends. An evaluation scenario defines specific numerical values that express the above series of behaviors. Since the evaluation scenario is defined with specific numerical values, it can be evaluated by a virtual environment evaluation device 50 or a vehicle in the real world.

The scenario generation device 10 is configured to at least include a control unit 20 and an evaluation scenario storage unit 30. The control unit 20 may be realized by a configuration including at least one processor. For example, the control unit 20 may be realized by a computer including a processor, a non-volatile memory, RAM, I/O, and a bus line connecting these components. The non-volatile memory stores a scenario generation program for operating a general-purpose computer as the control unit 20. When the processor executes the program stored in the non-volatile memory by using a temporary storage function of the RAM, the control unit 20 serves as a candidate scenario generation unit 21, a real environment scene obtaining unit 22, a filter generation unit 23, and an evaluation scenario determination unit 24. Serving these functions means that a scenario generation method corresponding to a scenario generation program is performed.

The candidate scenario generation unit 21 generates a candidate scenario that is a candidate for the evaluation scenario. Candidate scenarios are generated so as to cover theoretically plausible scenarios as much comprehensively as possible. In order to improve the comprehensiveness, a candidate scenario is generated, which takes into consideration one or both of a cognitive performance and a vehicle motion performance for responding to a traffic disturbance scenario that is based on a basic vehicle movement.

The basic vehicle movements are lane keep, lane change and the like. The evaluation scenario is a scenario for evaluating safety when a traffic disturbance occurs with respect to the basic vehicle operation. The traffic disturbance refers to dangerous traffic situations that possibly occur as a combination of road structure, a vehicle behavior, and a position and movement of surrounding vehicles, which pose threat or danger to the subject vehicle.

The cognitive performance is a performance related to cognition when the vehicle control is divided into three elements, i.e., cognition, judgment, and operation.

The cognitive performance is a performance of a sensor system related to cognition, which is installed on the subject vehicle. The sensor system includes one or more sensors such as a camera, a millimeter wave radar, and a lidar. The cognitive performance is described concretely in the following. For example, in terms of a millimeter-wave radar, the maximum detection distance, a detection range, a resolution, and the like. The maximum detection distance, the detection range, the resolution, and the like are basic performance or static performance. The cognitive performance changes dynamically due to cognitive disturbance.

The cognitive disturbance means a disturbance in a cognitive process. The cognitive disturbance means a state in which the sensor system fails to recognize information that should be recognized. An example of a cognitive disturbance is a state in which a camera, a millimeter wave radar, a lidar, or the like has a surrounding vehicle as an obstacle, which prevents cognition by those devices in terms of a field behind the surrounding vehicle. Lowered degree of cognition due to dirt on the sensor may also be an example of a cognitive disturbance. Cognitive disturbances include sensor blind spots and communication disturbances.

The vehicle motion performance is a performance related to operation when the vehicle control is divided into three elements: cognition, judgment, and operation. The vehicle motion performance includes a deceleration performance, an acceleration performance, and a steering performance. The vehicle motion performance changes dynamically due to a vehicle motion disturbance.

The vehicle motion disturbance means a situation in which the vehicle may possibly lose control when it is supposed to be in a controlled state. The vehicle motion disturbance includes factors inside the vehicle and factors outside the vehicle. Factors inside the vehicle include, for example, a gross vehicle weight and a weight balance. Factors outside the vehicle include road surface irregularities, road surface slopes, wind and the like.

The evaluation scenario is a scenario for evaluating whether or not the vehicle collides with a traffic participant or a structure therearound, i.e., in the vicinity of the vehicle. To evaluate such a scenario, first consider a traffic disturbance scenario. The evaluation scenario may be describable as a scenario in which whether a collision occurs or not even when a cognitive disturbance and a vehicle disturbance are added, based on a traffic disturbance scenario.

Therefore, a traffic disturbance scenario is explained. The traffic disturbance scenario of the other vehicle with respect to the subject vehicle may be defined by a combination of three elements of “road shape”, “subject vehicle movement”, and “other vehicle movement”. The subject vehicle movement may be divided into “lane keep” and “lane change”. The other vehicle movement may be divided into “deceleration”, “cut-in” and “cut-out”. By combining the elements of the subject vehicle and other vehicle, 3×2=6 scenarios may be obtained.

“Deceleration” means that the other vehicle in front of the subject vehicle in the same lane approaches the subject vehicle. “Cut-in” is a movement in which the other vehicle in a different lane from the subject vehicle moves to the same lane as the subject vehicle. “Cut-out” is a movement in which the other vehicle traveling in front of the subject vehicle in the same lane moves to the other lane.

The movements of the subject vehicle and the other vehicle may be represented by a mathematical model. In other words, the traffic disturbance may be represented by a mathematical model. A mathematical model means representation using an equation. As an example, a mathematical model representing a “deceleration” of the other vehicle will be described.

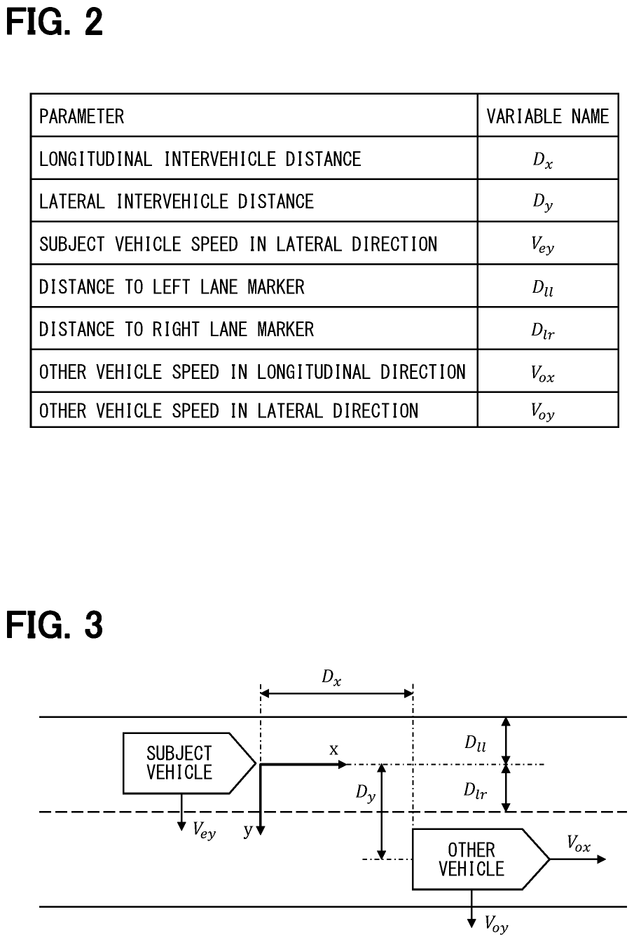

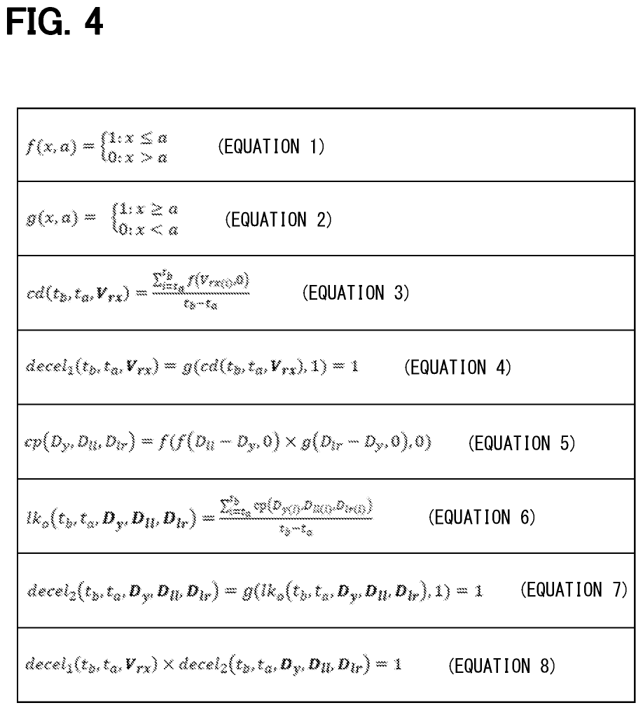

The “deceleration” of the other vehicle may be represented, for example, by parameters shown in FIG. 2. The coordinate system of the parameters shown in FIG. 2 is shown in FIG. 3. Using the parameters shown in FIG. 2, the “deceleration” of the other vehicle movement may be represented based on equations 1 and 2 shown in FIG. 4.

When the other vehicle is decelerating, it may be considered that the following two conditions are satisfied. Condition 1 is that the subject vehicle is close to the other vehicle in a front-rear (i.e., longitudinal) direction. Condition 2 is that the other vehicle and the subject vehicle are traveling in the same lane. When the condition 1 is satisfied, ta≤t≤tb, and a relative speed (Vrx=Vox−Vex) is continuously kept in a negative value. Therefore, an average value of f(Vrx (i), 0) becomes 1. Equations 3 and 4 are obtained based on the above.

When the condition 2 is satisfied, the distance to a left lane marker from the other vehicle is a negative value, and the distance to a right lane marker is a positive value. Therefore, Dy (i)−Dll (i)<0 and Dy (i)−Dlr (i)>0 are continuously satisfied. We define a function cp to find a product of these two. The function cp is shown as Equation 5.

When the function cp is 1, the subject vehicle and the other vehicle are traveling in the same lane. When the function cp is 0, the subject vehicle and the other vehicle are traveling in different lanes. When to t tb and the average of the functions cp is 1, the condition 2 is satisfied. Equations 6 and 7 represent the above. When the result of taking AND of Equation 4 and Equation 7 becomes 1, that is, when Equation 8 is satisfied, the other vehicle is decelerating.

Although the description of the mathematical model is omitted for the subject vehicle movement and the other vehicle movement other than the deceleration of the other vehicle, the subject vehicle movement and the other vehicle movement other than the deceleration of the other vehicle can also be represented by the mathematical model. Therefore, the traffic disturbance can be represented by the mathematical model.

Next, a mathematical model of cognitive performance is specifically described. As described above, the cognitive performance is represented by parameters, i.e., by the maximum detection distance and the like. The cognitive performance may preferably be represented by a model in consideration of cognitive disturbance. As a cognitive disturbance, a decrease in reception sensitivity in a millimeter wave radar may be exemplified. Due to the decrease in reception sensitivity, the maximum detection distance decreases. Therefore, a relationship between the decrease in reception sensitivity and the maximum detection distance may be represented by a mathematical model.

Next, a mathematical model of vehicle motion performance is described. The vehicle motion performance may be modeled because it is a deceleration performance, an acceleration performance, a steering performance, and the like. For example, the deceleration performance may be modeled with parameters such as a deceleration start speed, a vehicle weight, a brake oil pressure and the like. It may be preferable that the vehicle motion performance is also a model in consideration of the vehicle motion disturbance. A road surface frictional resistance may be exemplified as a vehicle motion disturbance. The smaller the road surface friction resistance is, the longer the shortest stopping distance becomes. Therefore, the shortest stopping distance may be represented by a model including the road surface friction resistance.

The candidate scenario generation unit 21 comprehensively generates candidate scenarios based on the traffic disturbance scenario in consideration of the cognitive performance and the vehicle motion performance. By variably changing various concrete values to be input to the parameters in the scenario represented by the mathematical model, it is possible to generate a concrete candidate scenario comprehensively covering a parameter change range in the scenario. By what pitch the specific values to be input to the parameters are changed may be appropriately determinable based on the required evaluation accuracy.

Comprehensiveness of the candidate scenarios is guaranteeable when candidate scenarios are generated by variably changing the specific values to be input to the parameters for each of a large number of mathematical models. However, the number of the candidate scenarios is enormous. Therefore, the scenario generation device 10 narrows down, i.e., sifts, the candidate scenarios by a filter 25 generated by statistically processing the real environment scenes, and determines an evaluation scenario.

The real environment scene obtaining unit 22 extracts the real environment scenes to be statistically processed from the travel data storage unit 40. A scene is a concept similar to a scenario, and means, just like the scenario, a series of behaviors of traffic participants in and around the subject vehicle. Assuming that a scenario is an expected behavior, a scene may primarily be distinguished therefrom as an actually-observed behavior observed in the real environment. However, a scene may also be considered as a part of a scenario. Therefore, when clarifying that a scene involves a real environment, it is designated as a real environment scene. Note that a scene may include an entire scenario.

The travel data storage unit 40 stores a travel database in which travel data measured by a measurement vehicle, which is a real vehicle, is stored. The travel data measured by the measurement vehicle may include, in addition to data that appears outside the measurement vehicle such as a vehicle speed, an acceleration, and a position of the measurement vehicle, data indicative of a control amount of an actuator in the vehicle such as an accelerator opening, a brake oil pressure, a steering angle and the like. Further, the travel database may include travel data observed at an observation point in addition to the travel data measured by the measurement vehicle.

The travel data storage unit 40 does not need to be included in the scenario generation device 10. The scenario generation device 10 may at least be capable of reading the travel data from the travel data storage unit 40. The travel data storage unit 40 may be connected to the scenario generation device 10 by a wired or wireless network.

The real environment scene obtaining unit 22 obtains a travel data indicative of the real environment scene from the travel data storage unit 40 based on an extraction logic set in advance. The real environment scene means a travel scene occurring in the real environment. The extraction logic may be determined for each vehicle control function. Examples of the vehicle control function may include an adaptive cruise control and a collision damage mitigation braking system. However, the vehicle control function is not limited to the above. The reason why the extraction logic is determined for each vehicle control function is that the scenes that need to be evaluated differ depending on the respective vehicle control functions.

For example, for the evaluation of a collision damage mitigation braking system, it is necessary to extract scenes in which the other vehicle cuts in and scenes in which the other vehicle slows down, but it is not necessary to extract scenes in which the other vehicle cuts out and scenes in which the other vehicle accelerates. On the other hand, for the evaluation of an adaptive cruise control, it is necessary to extract scenes in which the other vehicle accelerates.

The extraction logic may be any logic that can extract the required scenes determined for each of the vehicle control functions. It may be preferable that the extracted scenes include (i) safe scenes in which the vehicle is traveling safely by using the vehicle control function(s), in other words, standard scenes and (ii) dangerous scenes.

As long as these scenes are extractable, the real environment scene obtaining unit 22 may manually obtain these scenes. Further, the extraction logic may be generated by machine learning based on the scenes obtained manually by the user. Further, as the logic to be extracted, a traffic disturbance scenario required for the evaluation of the vehicle control function may be used.

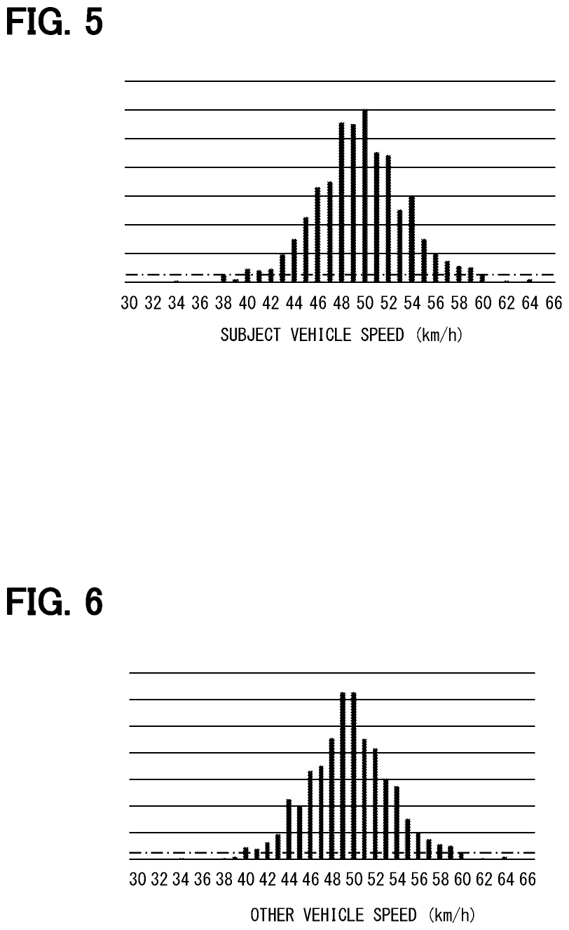

The filter generation unit 23 performs frequency analysis using the travel data indicative of the real environment scene obtained by the real environment scene obtaining unit 22 as analysis target data. The frequency analysis results are illustrated in FIGS. 5 and 6. FIG. 5 is a diagram showing a frequency distribution of the subject vehicle speeds extracted from the travel data indicative of the real environment scenes that are extracted by the real environment scene obtaining unit 22. FIG. 6 is a diagram showing a frequency distribution of the other vehicle speeds extracted from the same travel data as FIG. 5. The horizontal axis of FIGS. 5 and 6 is speed (km/h), and the vertical axis is frequency.

In FIGS. 5 and 6, a broken line is a preset extraction threshold value. The extraction threshold value may be preferably set to a small value so that there is no omission of extraction of the scene that may occur in the real world. Note that the extraction threshold value may be the same value regardless of the parameters, or may be different for parameter to parameter. In FIG. 5, the frequency continuously exceeds the extraction threshold value in the range of 40 km/h to 60 km/h. Also in FIG. 6, the frequency continuously exceeds the extraction threshold value in the range of 40 km/h to 60 km/h. An example of the filter 25 generated based on the frequency analysis results shown in FIGS. 5 and 6 is a filter 25 that extracts a range from 40 km/h to 60 km/h for both of the subject vehicle speed and the other vehicle speed. Is.

Note that the filter 25 generated by the filter generation unit 23 may define an extraction range for three or more types of parameters. Further, the extraction range may be defined for only one type of parameter.

The evaluation scenario determination unit 24 filters the comprehensive candidate scenarios generated by the candidate scenario generation unit 21 by the filter 25 generated by the filter generation unit 23. The evaluation scenario determination unit 24 stores the filtered scenario as an evaluation scenario in the evaluation scenario storage unit 30.

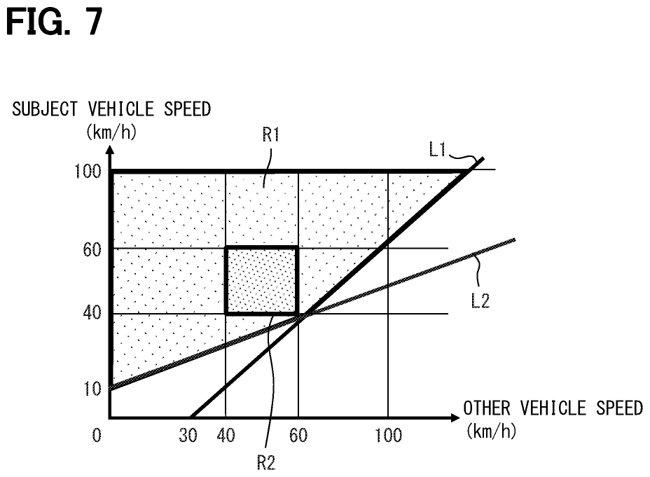

The filtering performed by the evaluation scenario determination unit 24 is specifically described with reference to FIG. 7. Note that FIG. 7 is a diagram for conceptually explaining the filtering, and easy-to-understand numerical values are used for the parameters. In FIG. 7, an area R1 is an area in which candidate scenarios exist. Boundary lines L1 and L2 are lines determined by the mathematical model used when generating the candidate scenario. The area R1 is an area surrounded by the boundary lines L1 and L2, a line indicating that the other vehicle speed is 0 km/h, and a line indicating that the subject vehicle speed is 100 km/h. The candidate scenarios exist evenly spread in the area R1. Note that, with regard to the scenarios obtained in the real environment, there are a portion with many scenarios and a portion with few scenarios in the area R1. The area R2 is an area extracted by the filter 25.

The evaluation scenario determination unit 24 extracts the candidate scenarios in the area R2 from among the candidate scenarios generated by the candidate scenario generation unit 21, that is, the candidate scenarios existing in the area R1 are extracted by the filter 25.

Note that, in the example of FIG. 7, the area R2 is an area completely included in the area R1. However, various logics are available as an extraction logic used when the real environment scene obtaining unit 22 extracts the real environment scene. Depending on a specific extraction logic, a part of the area R2 may be outside the area R1.

The evaluation scenario storage unit 30 is a writable storage unit. The evaluation scenario storage unit 30 stores the evaluation scenarios determined by the evaluation scenario determination unit 24.

The virtual environment evaluation device 50 is a device that evaluates, in the virtual environment, the evaluation scenarios stored in the evaluation scenario storage unit 30. The virtual environment evaluation device 50 is a simulation device for traveling a virtual vehicle in a virtual environment, and is realized by a computer executing a simulation program. The virtual vehicle virtually includes sensors, actuators for controlling the vehicle, vehicle control applications, and the like. In the virtual environment, the weather, day and night, traffic participants, and the like may be virtually set. Each of the evaluation scenarios is evaluated by the virtual environment evaluation device 50.

When an evaluation scenario is evaluated by the virtual environment evaluation device 50, simulation results indicating that an accident occurs in the evaluation scenario may be obtained. The evaluation results may be fed back to modifications of one or both of an algorithm and parameters of the vehicle control applications.

### Summary of the First Embodiment

In the scenario generation device 10 of the first embodiment described above, the candidate scenario generation unit 21 generates candidate scenarios based on a mathematical model. Therefore, candidate scenarios are comprehensively generated. Further, the evaluation scenario determination unit 24 determines the evaluation scenario(s) by filtering the candidate scenarios. In such manner, the number of evaluation scenarios is reducible/suppressible.

The filter generation unit 23 generates the filter 25 used for the filtering based on the frequency analysis results of the real environment scenes. By filtering using this filter 25, it is possible to exclude, from the candidate scenarios, scenarios related to scenes that do not occur in the real environment or are unlikely to occur in the real environment. Therefore, it is possible to increase the comprehensiveness of the scenarios that can occur in the real environment while suppressing the number of scenarios.

The candidate scenarios are determined based on the cognitive performance represented by the mathematical model, the traffic disturbance, and the vehicle motion performance. In such manner, the comprehensiveness of the candidate scenarios are improvable.

The real environment scene obtaining unit 22 extracts the real environment scenes by the extraction logic determined for each of the vehicle control functions. In such manner, the filter 25 generated by the filter generation unit 23 are appropriately made suitable for the specific vehicle control, thereby enhancing the validity of the evaluation scenarios extracted by the filter 25.

### Second Embodiment

The following describes the second embodiment. In the following description of the second embodiment, elements having the same reference numerals as those used so far are the same as the elements having the same reference numerals in the previous embodiment, except when specifically mentioned. When only a part of the configuration is described, the embodiment described above may be applied to other parts of such configuration.

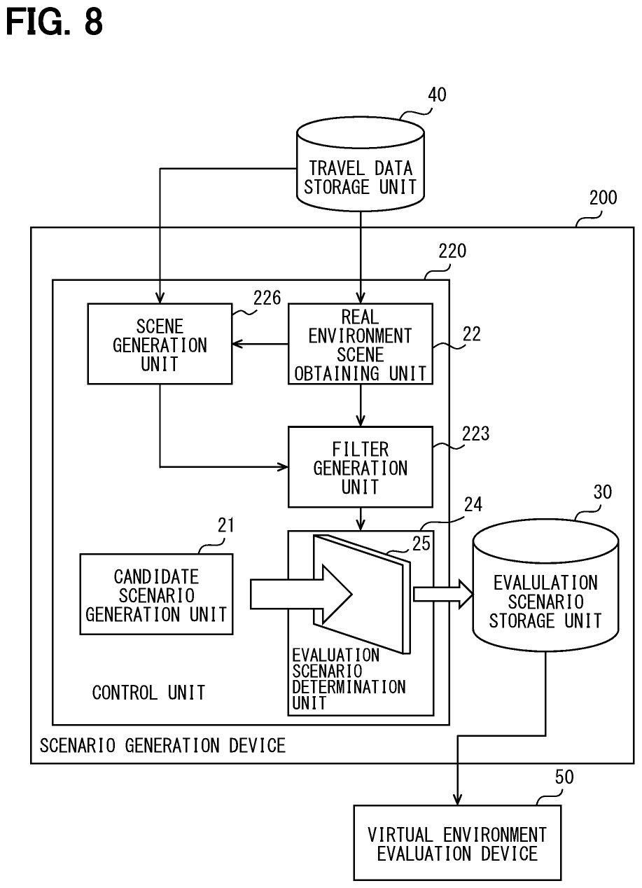

FIG. 8 shows a scenario generation device 200 of the second embodiment. In the scenario generation device 200, the processing performed by a control unit 220 is different from that of the control unit 20 of the first embodiment. The control unit 220 is different from the control unit 20 of the first embodiment in that the processing of a filter generation unit 223 is partially different from the processing of the filter generation unit 23, and a scene generation unit 226 is provided.

The scene generation unit 226 generates a travel scene by receiving travel data stored in the travel data storage unit 40 as an input thereto. The scene generation unit 226 includes a generator having learned by machine learning, and inputs travel data indicative of at least one travel scene stored in the travel data storage unit 40 into the generator.

The generator is learned, or is prepared to understand, so to say, using a part or all of the real environment scenes extracted by the real environment scene obtaining unit 22. A part of the real environment scene is, for example, a dangerous scene preset for each of the vehicle control functions.

There is known a technique of predicting an entire travel scene from travel data shorter than the learned travel scene by learning (e.g., machine learning) the travel scene. This technique is used for risk prediction and the like. In the present embodiment, the generator learned as described above is used, and the travel scene is generated by inputting the travel data not used for the learning. The travel scene generated in such manner shows a travel scene similar to the real environment scene used for the learning of the generator.

The scene generation unit 226 may preferably select one or more parameters included in the travel data used for learning, and may perform a frequency analysis of the travel data used for learning with respect to the selected parameters. Based on such frequency analysis result, as the travel data to be input, the travel data close to the travel data used for the learning is selected. For example, it is assumed that the parameters α are α1 to α2 (α1<α2) as a result of frequency analysis. In such case, as the travel data to be input, the travel data in which the parameter α is in a range of α1−Δβ to α1 or α2+Δβ is selected. In such manner, it is possible to prevent the generated travel scene from being significantly different from the real environment scene used for the learning.

The filter generation unit 223 adds not only the travel data indicative of the real environment scene obtained by the real environment scene obtaining unit 22 but also the travel data generated by the scene generation unit 226 to the frequency analysis target data. Except for the above-described points, the processing performed by the filter generation unit 223 is the same as that of the filter generation unit 23.

### Summary of the Second Embodiment

The scenario generation device 200 of the second embodiment includes the scene generation unit 226. The scene generation unit 226 includes a generator that is learned using a part or all of the real environment scenes extracted by the real environment scene obtaining unit 22. The scene generation unit 226 can generate the travel data indicative of a travel scene similar to the real environment scene extracted by the real environment scene obtaining unit 22 from the travel data not extracted by the real environment scene obtaining unit 22.

Then, the filter generation unit 223 statistically processes not only the travel data indicative of the real environment scene but also the travel data generated by the scene generation unit 226. In such manner, even when the amount of the travel data stored in the travel data storage unit 40 is small, it is possible to increase the number of travel scenes for the frequency analysis by the filter generation unit 223. As a result, the quality of the filter 25 generated based on the frequency analysis result is improvable even when the amount of the travel data stored in the travel data storage unit 40 is small.

Although the embodiments have been described above, the disclosed technology is not limited to the above-described embodiments, and the following modifications are also included in the disclosed scope, and various modifications may be made without departing from the spirit of the present disclosure.

### First Modification

The scenario generation device 10 in the above-described embodiments includes the candidate scenario generation unit 21 for generating a candidate scenario. However, candidate scenarios are scenarios that may be generated independently of the real environment. Therefore, the candidate scenario only needs to be generated once, and it is not necessary to create it every time it is required. Therefore, the scenario generation device 10 needs not include the candidate scenario generation unit 21 if the candidate scenario is obtained from the outside or is stored in advance.

### Second Modification

The scene generation unit 226 may generate a travel scene by using, as input data, the travel data included in the travel scene used for learning. Even when the travel data included in the travel scene used for learning is used as input data, the travel scene matching the travel scene used for learning will not always be generated. Therefore, the number of travel scenes may also be increased in the above-described manner.

Further, a plurality of travel scenes generated by the scene generation unit 226 may be narrowed down, based on the same condition as the one used to extract the travel data from the travel data storage unit 40 by the real environment scene obtaining unit 22, and the extracted travel data in such manner may be used as analysis target data.

### Third Modification

In the above-described embodiments, the evaluation scenario is evaluated by the virtual environment evaluation device 50 (i.e., in the virtual environment). However, the evaluation scenario may be evaluated in a real vehicle (i.e., in the real environment). Further, the evaluation scenario may be evaluated by HILS (Hardware In the Loop Simulator/Hardware In the Loop System), which is an evaluation device that combines hardware and software.

### Fourth Modification

The control units 20, 220 and methods thereof described in the present disclosure may be realized by a dedicated computer constituting a processor programmed to perform one or more functions embodied by a computer program.

Alternatively, the control units 20, 220 and the methods thereof described in the present disclosure may be realized by a dedicated hardware logic circuit. Alternatively, the controls 20, 220 and methods thereof described in the present disclosure may be realized by one or more dedicated computers provided as a combination of (i) a processor that performs a computer program and (ii) one or more hardware logic circuits. The hardware logic circuit may be, for example, ASIC or FPGA.

The storage medium for storing the computer program is not limited to ROM. Alternatively, the computer program may be stored in a computer-readable, non-transitory, tangible storage medium as instructions to be performed by a computer. For example, the program may be stored in a flash memory.

What is claimed is:

1. A scenario generation device comprising:
a real environment scene obtaining unit obtaining a real environment scene, which is a scene that occurs in a real environment, from a travel database that stores travel data of a real vehicle;
a filter generation unit generating a filter based on a frequency analysis result of analysis target data including the travel data indicative of the real environment scene; and
an evaluation scenario determination unit determining an evaluation scenario by filtering candidate scenarios using the filter generated by the filter generation unit, the candidate scenarios being comprehensively generated based on a mathematical model.

2. The scenario generation device according to claim 1, wherein
the candidate scenario is a scenario determined based on at least one of a cognitive performance, a traffic disturbance, and a vehicle motion performance that are represented by a mathematical model.

3. The scenario generation device according to claim 1, wherein
the real environment scene obtaining unit extracts the real environment scene from the travel database by using an extraction logic defined for each of vehicle control functions.

4. The scenario generation device according to claim 1 further comprising:
a scene generation unit including a generator generating travel data indicative of a travel scene, the generator being learned by the real environment scene obtained by the real environment scene obtaining unit with the travel data stored in the travel database as an input, wherein
the filter generation unit adds the travel data generated by the scene generation unit to the analysis target data in addition to the travel data indicative of the real environment scene.

5. A scenario generation method comprising the steps of:
obtaining a real environment scene, which is a scene that occurs in a real environment, from a travel database that stores travel data of a real vehicle;
generating a filter based on a frequency analysis result of analysis target data including the travel data showing the real environment scene; and
determining an evaluation scenario by filtering candidate scenarios using the filter, the candidate scenarios being comprehensively generated based on a mathematical model.

6. A scenario generation device comprising:
at least one processor; and
at least one non-transitory computer readable storage medium storing a program, when executed by the at least one processor, causing the at least one processor to:
obtain a real environment scene, which is a scene that occurs in a real environment, from a travel database that stores travel data of a real vehicle;
generate a filter based on a frequency analysis result of analysis target data including the travel data indicative of the real environment scene; and
determine an evaluation scenario by filtering candidate scenarios using the generated filter, the candidate scenarios being comprehensively generated based on a mathematical model.
